(19) United States
(12) Patent Application Publication
(10) Pub. No.: US 2019/0137539 A1
(43) Pub. Date: May 9, 2019

(54) SYSTEMS AND METHODS FOR ESTIMATING A CONDITION FROM SENSOR DATA USING RANDOM FOREST CLASSIFICATION

(71) Applicant: International Technological University Foundation, Inc., San Jose, CA (US)

(72) Inventors: Karl Lin WANG, Los Altos, CA (US); Jingya XU, San Jose, CA (US)

(73) Assignee: International Technological University Foundation, Inc., San Jose, CA (US)

(21) Appl. No.: 15/806,275

(22) Filed: Nov. 7, 2017

(51) Int. Cl. G01P 21/00; G06N 7/00

(52) U.S. Cl. CPC G01P 21/00; G06N 7/005

(57) ABSTRACT

Various embodiments of the invention allow for improving measurement accuracy of monitoring devices, for example, to accurately determine speed from motion data measured by an accelerometer. In certain embodiments, this is accomplished by applying a classification process that resembles a random forest classification to recorded sample data to detect similarities to features associated with data for a known speed type, classifying sample data into speed types, and finally averaging the speed types to obtain a high accuracy estimate value for a final speed.

### TECHNICAL FIELD

The present disclosure relates to improving measurement accuracy in sensor systems. More particularly, the present disclosure is related to systems and methods for improving measurement accuracy of monitoring devices such as accelerometers used in wearable devices.

### DESCRIPTION OF THE RELATED ART

The ability of accurately measuring motion (e.g., speed and acceleration) is one of the important factors in the development of wearable devices. This is especially true for devices that measure caloric expenditure while the wearer of the device is in motion, e.g., during physical exercise.

Existing approaches that use classic integration of accelerometer data to measure speed suffer from difficulties of implementing those approaches into practice. This is mainly due to high sampling rate requirements and inherent accelerometer noise that causes a drift of the integration constant. Other approaches have their own drawbacks, and methods that rely on GPS data have limited applications.

One approach that applies a random forest classification method to acceleration data to classify modes of transportation, such as walking or using a bike, car, or train, completely fails to address accurate measuring of speed.

Accordingly, what is needed are systems and methods that improve the measurement accuracy of monitoring devices, including those that measure speed.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates an exemplary use of sensor data to generate records for different speed types, according to various embodiments of the present disclosure.

FIG. 2 illustrates generation of features from raw measurement data for use in a classification process, according to various embodiments of the present disclosure.

FIG. 3 is a flowchart of an illustrative process for randomly selecting features and records, according to various embodiments of the present disclosure.

FIG. 4 illustrates a matrix comprising calculated differences between pairs of feature values, according to various embodiments of the present disclosure.

FIG. 5 is a flowchart of an illustrative classification process for determining a speed type, according to various embodiments of the present disclosure.

FIG. 6 illustrates a selection process for potential speeds using feature values that were obtained by the process in FIG. 3.

FIG. 7 illustrates a method for an exemplary classification process for estimating speed based on decisions made by decision units in a random forest, according to various embodiments of the present disclosure.

FIG. 8 is a flowchart of a machine learning process illustrating a feature set reduction for the classification decision process in FIG. 6.

FIG. 9 is a flowchart of a machine learning process illustrating decision unit replacement and/or elimination, according to various embodiments of the present disclosure.

FIG. 10 depicts a block diagram of an information handling system/computing system according to embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

Furthermore, it shall be noted that: (1) certain steps may optionally be performed; (2) steps may not be limited to the specific order set forth herein; (3) certain steps may be performed in different orders; and (4) certain steps may be done concurrently.

Furthermore, it shall be noted that embodiments described herein are given in the context of estimating speed from motion data, but one skilled in the art shall recognize that the teachings of the present disclosure are not limited to estimating speed or the use of motion data and may equally be applied to other contexts that may benefit from improving the accuracy of sensor data. In this document, the terms “speed” and “speed type” are used interchangeably.

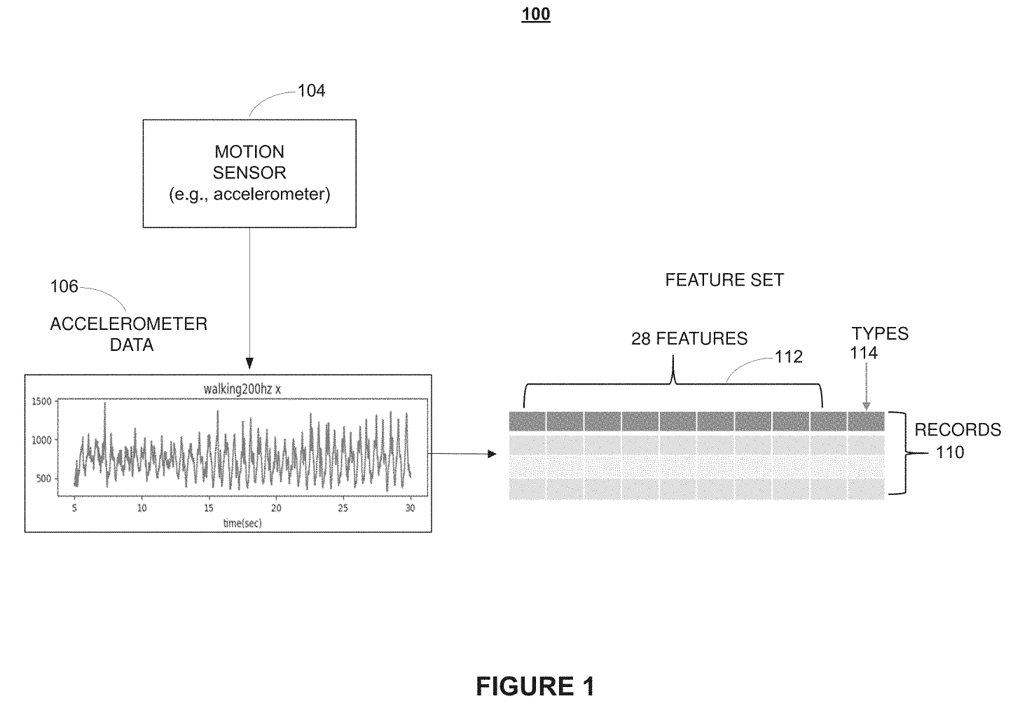

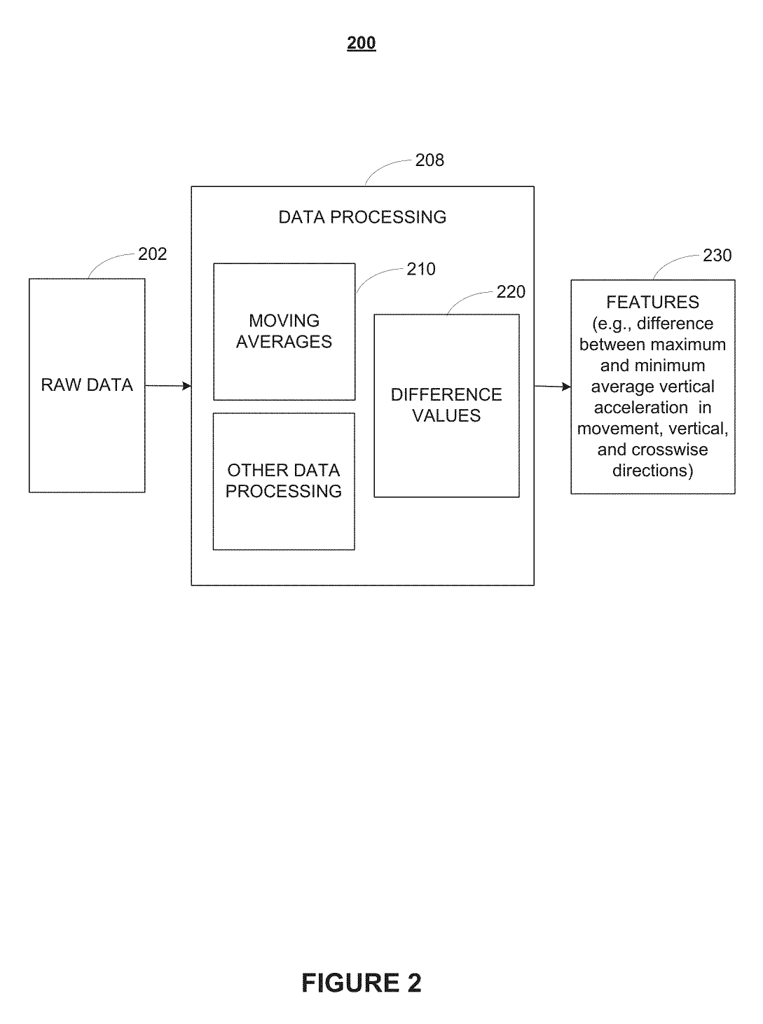

FIG. 1 illustrates the use of sensor data to generate records for different speed types, according to various embodiments of the present disclosure. Shown in FIG. 1 are motion sensor 104, accelerometer data 106, and records 110 generated from accelerometer data 106. As depicted, each record 110 may comprise features 112 that are associated with at least one speed type 114. The generation of features 112 from raw accelerometer data 106 is described in further detail with reference to FIG. 2.

Motion sensor 104 is any device that is capable of generating motion-related signals from which motion-related data may be derived. Sensor 104 may directly or indirectly (e.g., via a smart phone) communicate to a remote network. In embodiments, sensor 104 is an accelerometer that measures acceleration and outputs raw or pre-processed accelerometer data 106, for example, by measuring acceleration over a period of time and generating a desired number of records 110 or data sets from the measured accelerometer data 106. In embodiments, e.g., for increased accuracy, sampled accelerometer data 106 may comprise individualized data, such that the extracted feature values are customized for a particular user, gender, exercise style, age, or other desired category, for example, in a training session that samples a particular user profile or group to generate feature values that may be used in lieu of a default feature values.

In embodiments, motion sensor 104 samples accelerometer data 106 for certain periods of time and for a number of different but known speed types 114. For example, sensor 104 may sample accelerometer data 106 for a sampling time of 3 minutes at speeds 0.5 mph, 1 mph, 1.5 mph, and so on, up to a sample speed of, e.g., 10 mph. In embodiments, the sampling period may be divided into shorter time periods of accelerometer data 106 to which features 112 may be applied to extract feature values that may be assembled into data records 110.

In embodiments, a processor (not shown in FIG. 1) that may be internal or external to sensor 104 applies mathematical operations associated with features 112 to extract features values from some or all of accelerometer data 106 to generate records 110 for each known speed type 114. In embodiments, features 112 are a subset of features that is randomly selected from a larger set of features. For example, a subset of 5 features 112 may be selected from a feature set comprising 28 features, e.g., by using a random selection process. It is understood that any number of features, subfeatures, and speed types may be employed to accomplish the goals of the present invention.

In embodiments, the processor applies features 112 to accelerometer data 106 that has been measured during a 3-second time span to extract feature values for each speed type 114. For illustration purposes, only four records 110 that are associated with four different speed types 114 are displayed in FIG. 1. In embodiments, the processor may identify speeds associated with records 110 and randomly select records 110 representative of individual speed types 114 for any number of known speed types 114.

In embodiments, records 110 are partitioned, for example by using a random selection process, into a training set (e.g., 80% of records 110) and a test set (e.g., 20% of records 110) that serves as a validation data set. It is understood that some or all of the motion data gathering operations, feature selections, and record creations may be performed in a preliminary step prior to estimating or making decisions regarding a final speed.

FIG. 2 illustrates generation of features from raw measurement data for use in a classification process, according to various embodiments of the present disclosure. FIG. 2 depicts raw data 202, data processing 208 of raw data 202, and the creation of features 230. In embodiments, data processing 208 comprises the use of moving averages 210, difference values 220, and any other processing steps in the generation of features 230.

Raw data 202 is any sensor data that may be gathered, for example, at a known running speed and for a predetermined amount of time. In embodiments, raw data 202 comprises any type of motion-related data, such as velocity and acceleration data from which speed data may be gained. Acceleration data may comprise magnitude, orientation, and timing data related to an acceleration or velocity.

Moving averages 210 represent any processing of raw data 202. In embodiments, processing delivers information regarding minima, maxima, and average values derived from raw data 202. Difference values 220 represent any processing of raw data 202 and/or moving averages 210 from which, for example, comparative data may be derived. Features 230 represent any processed or pre-processed data that is derived from or calculated based on data processing step 208, and is not limited to moving averages 210 and/or difference values 220, but may include any other data processing steps.

In embodiments, raw data 202 is processed to generate frequency, average absolute acceleration and any permutation of a difference, D, in average absolute values of an acceleration for three axis x, y, and z for a suitable coordinate system. For example, D can be expressed as

D₁=|aₓ|−|a_{y}|−|a_{z}| (eq. 1)

D₂=|a_{y}|−|aₓ|−|a_{z}| (eq. 2)

D₃=|a_{z}|−|a_{y}|−|a_{y}| (eq. 3)

In embodiments, difference values 220 correspond to features 230 that may be used in a classification scheme according to various embodiments of the present disclosure. In embodiments, any number of features 230 may be applied to some or all of a set of sample data that is associated with a known walking or running speed so as to extract feature values for each speed type. The extracted feature values may then be assembled to generate records that are representative for each speed type, as shown in FIG. 1.

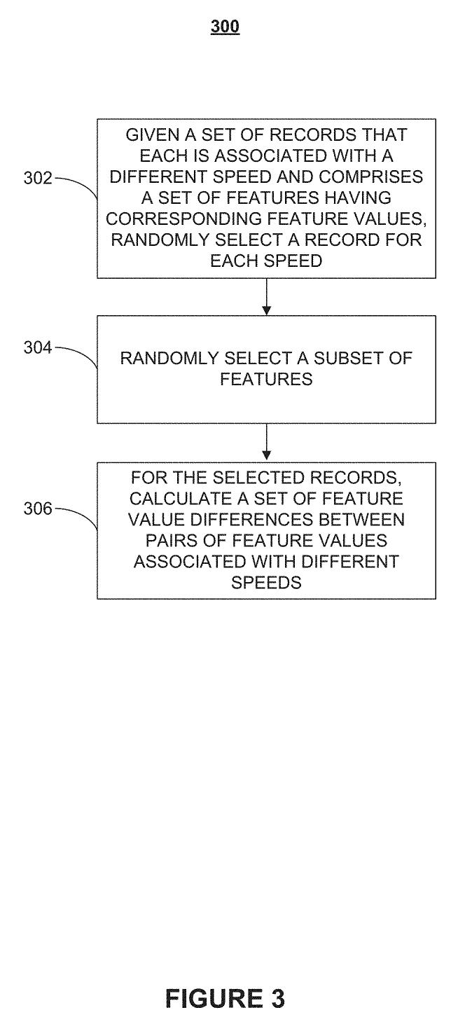

FIG. 3 is a flowchart of an illustrative process for randomly selecting features and records for each speed type, according to various embodiments of the present disclosure. Process 300 begins at step 302, for example, when motion sensor data, which may comprise any type of motion data, is received and assembled into records that each may be associated, e.g., with one particular speed. The data may comprise acceleration data from which speed data may be gained. In embodiments, the motion sensor data comprises acceleration data that may be received from any device that comprises an accelerometer. The records are each associated with a different speed and may comprise a set of features having corresponding feature values. In embodiments, for each type of speed, one record may be randomly selected into a set of records. Alternative, for each type of speed, the associated feature can be an average of the features from multiple records randomly selected into a set of records.

At step 304, a subset of features that may comprise any number of features is randomly selected from the set of features. It is understood that the subset may comprise some or all features in the set of features.

At step 306, the subset of features is applied to the selected records to obtain feature values for each selected record that is associated with a different speed. In embodiments, a set of feature value differences is calculated between pairs of feature values in the selected records. Alternative, in embodiments, for each type of speed, the associated feature can be an average of the features from multiple records randomly selected into a set of records.

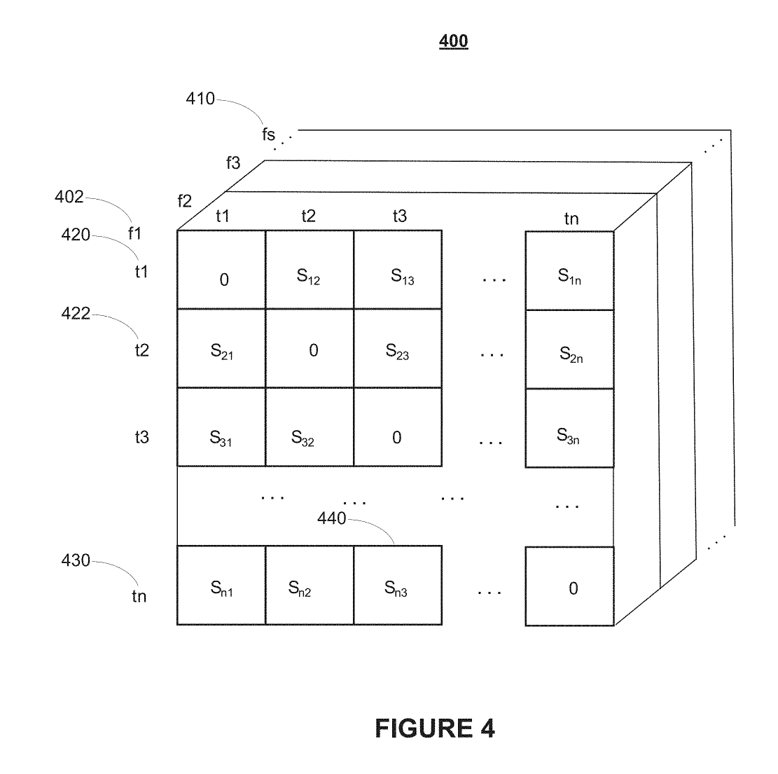

In embodiments, the calculated differences between pairs of feature values may define a matrix as illustrated in FIG. 4. Illustrated is a plane for a given feature f1 402 comprising calculated differences 440 between pairs of feature values, according to various embodiments of the present disclosure. As depicted, matrix 400 comprises s features 402-410 and n speed types, t, 420-430. In embodiments, features 402-410 define a subset of features that is randomly selected from a set of features. One of skill in the art will appreciate that any number of speed types 420-430 may be chosen to classify a sampled speed.

In embodiments, entries for a first feature, f1, 420 in matrix 400 comprise calculated distances between pairs of feature values, each pair being associated with two different speed types. Entries for a second feature, f2, 422 also comprise calculated distances between pairs of feature values, each pair being associated with two different speed types, and so on, until distances are calculated for all s features.

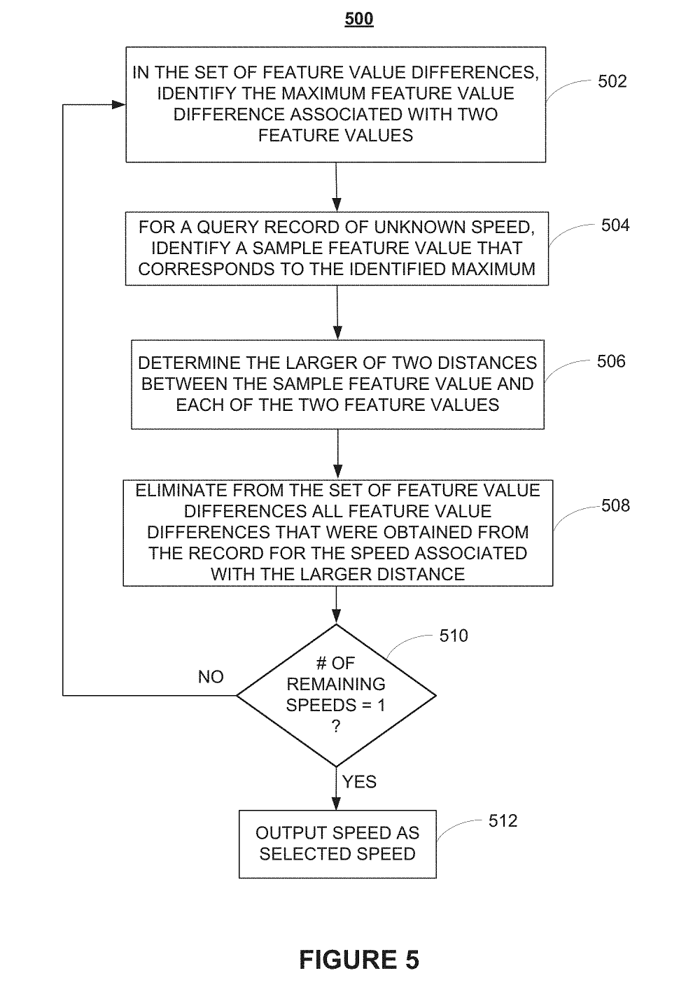

As a result, for each of the s features 402-410, a maximum difference may be calculated between feature values associated with different but known speeds 402-430. Using the maximum differences between speed types 402-430, a classification decision may be made to assign one of speed types 402-430 to sample data, as will be discussed next with reference to FIG. 5.

FIG. 5 is a flowchart of an illustrative classification decision process for determining a speed type, according to various embodiments of the present disclosure. Process 500 defines a decision unit that utilizes differences between pairs of speed types for a given set of features. In embodiments, process 500 begins at step 502 when a maximum is identified among differences in feature values, each feature value being associated with a different speed.

At step 504, a sample feature value is identified for a query record of unknown speed that may be received from a device such as a motion sensor that comprises an accelerometer. The sample feature value may correspond to the maximum feature value identified in step 502.

At step 506, it may be determined whether one feature value in a pair of feature values is farther away from the sample feature value than the other feature value in the pair.

Then, at step 508, all feature value differences that were obtained from the record for the speed associated with the farther distance may be eliminated from the set of feature value differences, in effect, eliminating that speed from the pool of potential speed types.

At step 510, it is determined whether there is only a single speed type remains that has not yet been eliminated. If so, process 500 outputs, at step 512, that remaining speed type as the chosen or estimated speed. Otherwise, if there remains more than one speed type in the pool of n possible speed types, process 500 may resume with step 502 by determining a new maximum difference among the remaining feature value differences and continue to eliminate potential speeds types until a single speed type estimate remains.

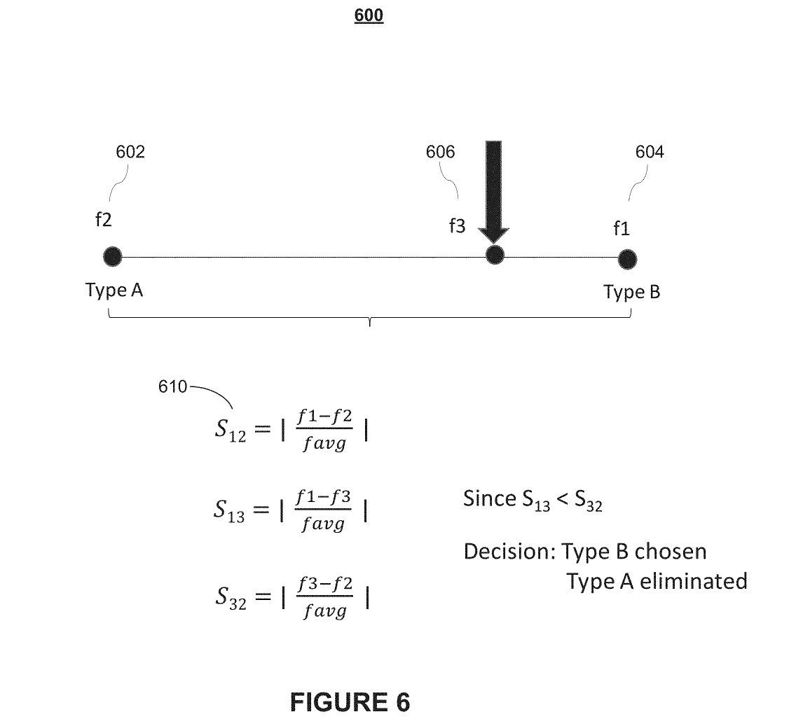

FIG. 6 illustrates a selection process for potential speeds using feature values that were obtained by the process in FIG. 3. In embodiments, a decision is made regarding a possible speed based on calculated distances between sample feature 606, which is associated with a sample data record, and a pair of feature values 602-604 associated with a particular feature, but different speed types. In detail, in embodiments, for a selected feature, f, the difference between the pair of feature values 602-604 may be expressed by distance function 610 defined as

$$S 12 = \vert \frac{f 1 - f 2}{favg\_i} \vert \qquad ( eq . 4 )$$

where f1 and f2 are feature values 602-604 associated with two different speed types, type A and type B, and where f avg_i is the average of all feature values for the selected feature across all selected speed types. For ith feature, f avg_i serves to normalize feature values 602-604 for a given feature and may be expressed as

$${f}_{avg\_i} = \frac{1}{n} {\sum }_{1}^{n} fi , l l = 1 to n \qquad ( eq . 5 )$$

Distance function 610 in Equation 4 uses f_{avg}_{_}ᵢ to normalize feature values 602-604 for different features.

In embodiments, the difference between pairs of feature values 602-604 are calculated from data records associated with different speeds, such that each pair of feature values 602-604 is associated with two different speed types. In effect, the distance between two data records may therefore be represented by the differences of their feature values 602-604 for a given feature.

As shown in example in FIG. 6, the distances between sample feature value f3 606 and feature value f2 (associated with speed type A) is greater than the distances between sample feature value f3 606 and feature value f1 (associated with speed type B). As a result, in a decision process, speed type A may be eliminated from consideration as potential speed type, keeping speed type B as potential speed.

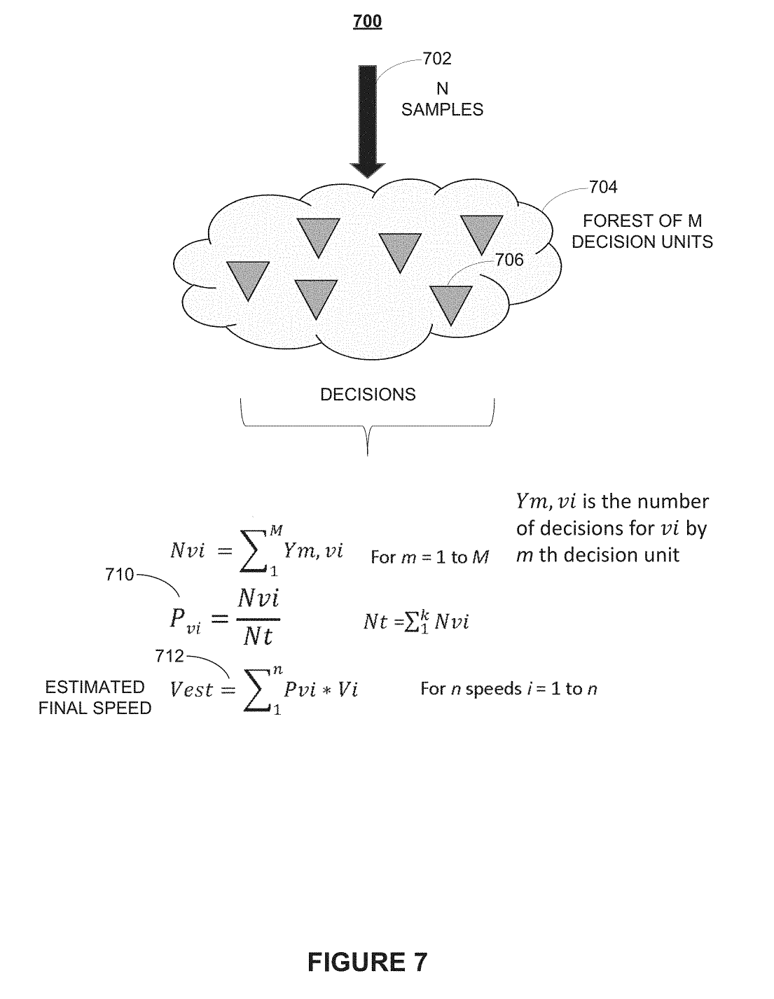

FIG. 7 illustrates a method for an exemplary classification process for estimating speed based on decisions made by individual decision units (or trees) in a random forest scheme, according to various embodiments of the present disclosure. In embodiments, for each non-discarded speed type that has been obtained by the random selection process described in FIG. 5, a classification probability 710 may be calculated.

In detail, in embodiments, a number of N test sample records (e.g., 1000 samples) 702 obtained from unknown speed data may be input to a random forest 704 that comprises a number of M decision units 706.

In embodiments, the number of decisions in favor of a given speed type, vi, is given by

Nvi=Σ₁^{M}Ym,vi (eq. 6)

for m=1 to M. In Equation 6, Ym, vi represents the number of decisions for vi by the m^{th} decision unit.

The classification probability 710 at a given speed may then be determined from the expression

$$Pvi = \frac{Nvi}{Nt} \qquad ( eq . 7 )$$

where Nvi represents the number decisions in favor of speed vi, and Nt represents the total number decisions for k speed types

Nt=Σ₁^{k}Nvi (eq. 8)

In embodiments, classification probabilities 710 and speeds Vi may be applied to the most likely speed estimation function 712 using the probability measurement given by Equation 7 for each speed type, such that the estimated final speed is given by

Vest=ΣᵢⁿPvi*Vi (eq. 9)

for n speeds, i=1 to n.

It is understood that the embodiments of the present disclosure are not limited to most likely speed estimates based on accelerometer data, but may equally be applied to any other type of sensor that operates under different conditions to determine any other most likely condition or discrete condition estimate. In embodiments, discrete condition estimates (e.g., final speeds) are averaged and assigned to one of a predetermined number of discrete conditions, thereby, e.g., to quantize outputs of a random forest scheme that is discussed with respect to FIG. 7.

In embodiments, an error between the predicted or estimated speed Vest and the actual speed, Vᵣₑₐₗ, may be defined as root mean square error expressed by

$${V}_{rmse} = \sqrt{\frac{{\sum }_{1}^{n} {( Vest - Vreal )}^{2}}{n}} \qquad ( eq . 10 )$$

Briefly returning to FIG. 7, a person of skill in the art will appreciate that the random selection process described in FIG. 5 may be used to create any number of decision units 706, and that any number of decision units 706 may be used to construct random forest 704.

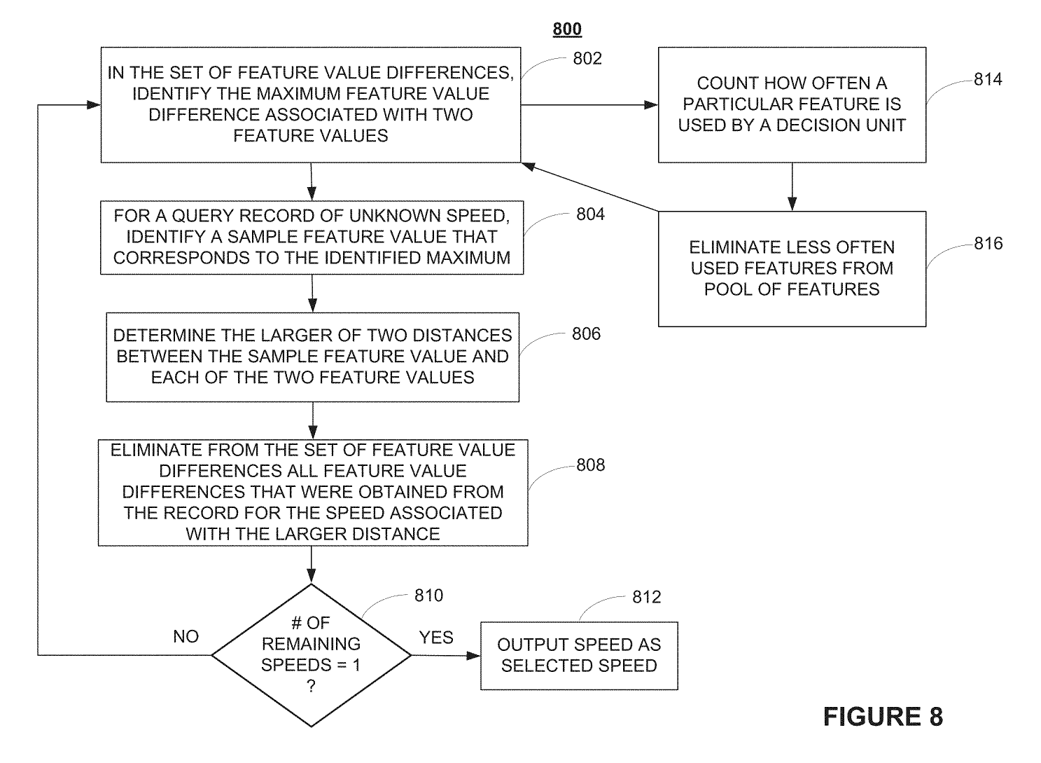

FIG. 8 is a flowchart of a machine learning process illustrating a feature set reduction for the classification decision process in FIG. 5. For clarity, steps similar to those in FIG. 5 are labeled in the same manner. For purposes of brevity, a description of their function within a decision unit is not repeated here.

Process 800 represents a decision unit in which features, which may have been selected from a larger set of features, are evaluated to improve classification accuracy of a decision process. In embodiments, process 800 comprises counting, at step 814, the number of occurrences that a particular feature corresponds to a speed that the decision unit has selected as the final speed.

In embodiments, features are ranked based on the number of counted occurrences. In other words, features involved in predicting final speeds more often are ranked higher than that have less predictive value. Intuitively, speeds associated with those features that provide large differences between feature values (i.e., large differences between speed types) are more likely to be selected.

In embodiments, at step 816, the less often used features are eliminated as less predictive from the pool of potential features, such that they are no longer used in the feature selection process. As a result, decisions will be made by using the most predictive features, thereby, improving the accuracy of the classification process. In addition, the reduced set of features greatly improves the computational speed of the processor (or processors), since the smaller data set results in a lower number of computations that need to be performed.

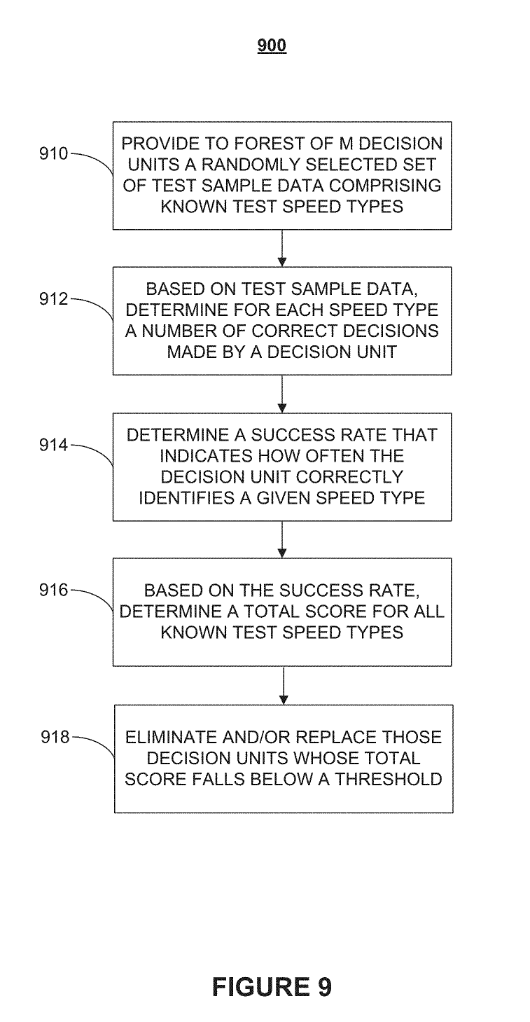

FIG. 9 is a flowchart of a machine learning process illustrating decision unit replacement and/or elimination, according to various embodiments of the present disclosure. Process 900 comprises a method for evaluating the accuracy of speed estimation by decision units and taking appropriate action. It is understood that the speed estimation accuracy may be expressed in form of an error value or a success rate (e.g., a percentage).

In embodiments, at step 910, a set of test sample data, Ntest, that comprises test sample features of known test speed types, vi, is provided to a random forest. Test sample data may be randomly selected from speed records and, as in FIG. 7, the random forest may comprise M decision units.

At step 912, the sample data is used to determine for each speed type, v, a number of correct decisions, Nm, made by a decision unit.

At step 914, based on the number of correct decisions, Nm, a success rate that indicates how often a decision unit correctly has identified a given speed type, vi, is determined. This may be accomplished, for example, by using expression

$$TPm , vi = \frac{Nm , vi}{Ntest} \qquad ( eq . 11 )$$

At step 916, based on the success rate, a total score for each of the n known test speed types may be calculated, for example, as

$$Score , m = \frac{1}{n} {\sum }_{1}^{n} TPm , vi \qquad ( eq . 12 )$$

where i=1 to n speed types.

At step 918, in embodiments, for a given decision unit, if the total score for the decision unit falls below a threshold (e.g., Score,m<80%), that decision unit may be eliminated. In embodiments, if one or more scores for a given decision unit fall below a threshold, that decision unit may be eliminated or replaced. In embodiments, if, for a given decision unit, the error, as

$$Error , m = \frac{1}{n} {\sum }_{1}^{n} ( 1 - TPm , vi ) \qquad ( eq . 13 )$$

is larger than an acceptable threshold level (e.g., 20%), that decision unit may be replaced by another decision unit. In addition, the number of decision units M in the forest may be increased. Conversely, in embodiments, if the error is lower than the threshold, the number of decision units in the forest may be reduced, for example, by eliminating one or more of those decision units that result in decisions having the largest errors.

Aspects of the present patent document are directed to information handling systems. For purposes of this disclosure, an information handling system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

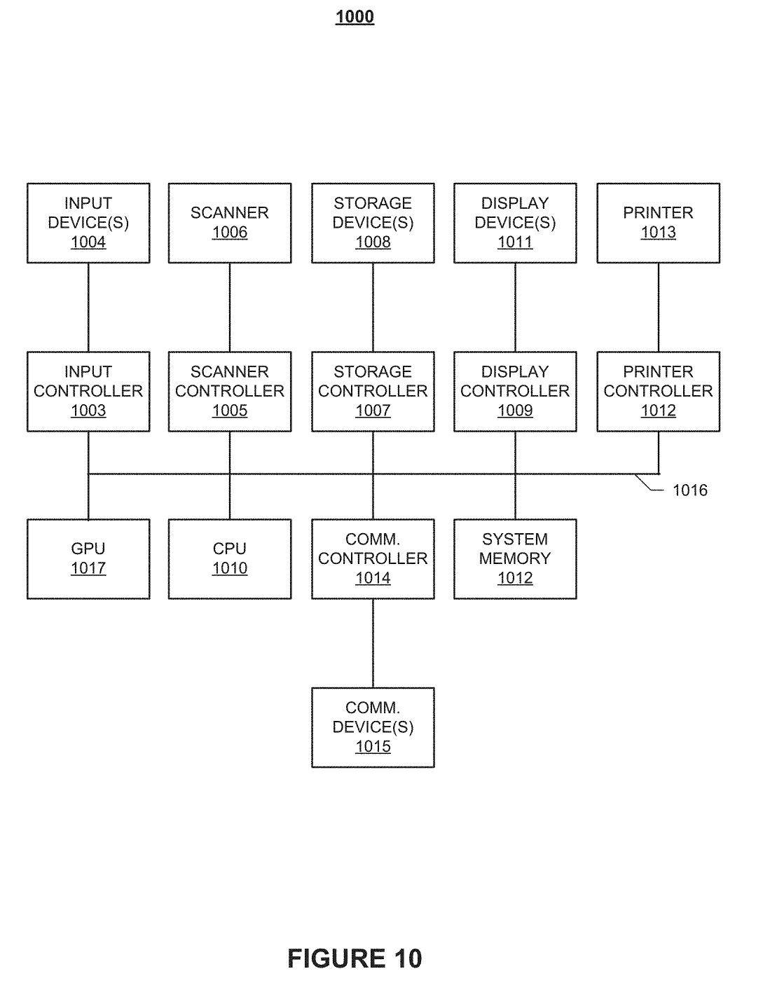

FIG. 10 depicts a block diagram of an information handling system according to embodiments of the present invention. It will be understood that the functionalities shown for system 1000 may operate to support various embodiments of an information handling system—although it shall be understood that an information handling system may be differently configured and include different components. As illustrated in FIG. 10, system 1000 includes a central processing unit (CPU) 1001 that provides computing resources and controls the computer. CPU 1001 may be implemented with a microprocessor or the like, and may also include a graphics processor and/or a floating point coprocessor for mathematical computations. System 1000 may also include a system memory 1002, which may be in the form of random-access memory (RAM) and read-only memory (ROM).

A number of controllers and peripheral devices may also be provided, as shown in FIG. 10. An input controller 1003 represents an interface to various input device(s) 1004, such as a keyboard, mouse, or stylus. There may also be a scanner controller 1005, which communicates with a scanner 1006. System 1000 may also include a storage controller 1007 for interfacing with one or more storage devices 1008 each of which includes a storage medium such as magnetic tape or disk, or an optical medium that might be used to record programs of instructions for operating systems, utilities and applications which may include embodiments of programs that implement various aspects of the present invention. Storage device(s) 1008 may also be used to store processed data or data to be processed in accordance with the invention. System 1000 may also include a display controller 1009 for providing an interface to a display device 1011, which may be a cathode ray tube (CRT), a thin film transistor (TFT) display, or other type of display. The computing system 1000 may also include a printer controller 1012 for communicating with a printer 1013. A communications controller 1014 may interface with one or more communication devices 1015, which enables system 1000 to connect to remote devices through any of a variety of networks including the Internet, an Ethernet cloud, a Fiber Channel over Ethernet (FCoE)/Data Center Bridging (DCB) cloud, a local area network (LAN), a wide area network (WAN), a storage area network (SAN) or through any suitable electromagnetic carrier signals including infrared signals.

In the illustrated system, all major system components may connect to a bus 1016, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It shall be noted that elements of the claims, below, may be arranged differently including having multiple dependencies, configurations, and combinations. For example, in embodiments, the subject matter of various claims may be combined with other claims.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A system for estimating a condition from sensor measurements, the system comprising:
a sensor that generates sensor data from a measured parameter, the sensor data being associated with a plurality of features; and
a processor coupled to the sensor to receive the sensor data, the processor generates a first decision unit that performs the steps of:
selecting a first set of records that each comprises a first set of features that have corresponding feature values, each record being associated with a different condition;
calculating a set of feature value differences between pairs of feature values associated with different conditions;
based at least in part on the measured parameter, determining a sample feature value for a query record comprising an unknown condition;
from the set of feature value differences, identifying a maximum value associated with a first feature value and a second feature value;
determining the greater of two differences between the sample feature value and each of the first and second feature values;
discarding from the set of feature value differences those that were obtained from the record for the condition associated with the greater of two differences;
returning to the step of identifying a maximum value until a single condition remains; and
responsive to the single condition remaining, outputting the single condition as a first estimated condition.

2. The system according to claim 1, wherein the processor comprises a second decision unit that randomly selects a second set of records that each comprises a second set of features, the second decision unit outputs a second estimated condition.

3. The system according to claim 1, further combining outputs of a plurality of decision units.

4. The system according to claim 1, wherein the outputs are quantized to correspond to non-numerical classifications.

5. The system according to claim 4, wherein the processor further calculates probabilities for at least the first and second estimated conditions to estimate a final condition.

6. The system according to claim 5, wherein the processor discards a less often used set of features to reduce a size of the feature set to improve at least one of an accuracy and a performance of estimating the final condition.

7. The system according to claim 1, wherein the sensor data comprises movement data that is customized for a particular user of the system.

8. The system according to claim 7, wherein the movement data comprises accelerometer data and the first estimated condition is a speed.

9. A method for using a first decision unit to estimate a condition from sensor measurements, the method comprising:
receiving sensor data associated with a plurality of features from which feature values are generated;
given a first set of records that each is associated with a different condition and comprises a first set of features that have corresponding feature values, calculating a set of feature value differences between pairs of feature values associated with different conditions;
for a record queried from the sensor data and comprising an unknown condition, determining a sample feature value;
determining the greater of two numerical distances between the sample feature value and each of the feature values in the pairs of feature values;
discarding from the set of feature value differences those that were obtained from the record for the condition associated with the greater of two numerical distances; and
upon feature values associated with a single condition remaining, outputting the single condition as a first estimated condition.

10. The method according to claim 9, wherein at least of the set of features and the first set of records has been randomly selected.

11. The method according to claim 9, further comprising generating a second decision unit that randomly selects a second set of records that each comprises a second set of features, the second decision unit outputs a second estimated condition.

12. The method according to claim 11, further comprising calculating probabilities for at least the first and second estimated conditions to estimate a final condition.

13. The method according to claim 12, further comprising ranking the set of features by how often a selected condition associated with a feature is selected as the final speed.

14. The method according to claim 13, further comprising discarding speeds corresponding to those features that are less often selected.

15. The method according to claim 9, further comprising: adjusting a number of decision units by:
providing to a random forest comprising the first and second decision units a set of sample data comprising test sample features of known test speed types;
for each speed type, determining a number of correct decisions made by each decision unit;
based on the number of correct decisions, determining a success rate that indicates how often a particular decision unit correctly identifies a given speed type;
using the success rate to calculate a total score for each of the known test speed types; and
based on the total score, identifying one or more decision units to be replaced or eliminated.

16. The method according to claim 15, wherein, if the total score for that particular decision unit falls below a threshold, performing the one of eliminating the particular decision unit and replacing the particular decision unit by a different decision unit.

17. The method according to claim 15, further comprising quantizing an output and associating the output with a non-numerical classification.

18. The method according to claim 15, wherein the total score is based on an error, and further comprising, in response to the error being lower than a threshold, reducing a number of decision units in the random forest by eliminating one or more decision units that generate decisions having errors above the threshold.

19. A system for estimating a speed from acceleration measurements, the system comprising:
a sensor that generates sensor data from a measured parameter, the sensor data being associated with a plurality of speeds; and
a processor coupled to the sensor to receive the sensor data, the processor generates a first decision unit that performs the steps of:
selecting a first set of records that each comprises a set of features that have corresponding feature values, each record being associated with a different speed;
calculating a set of feature value differences between pairs of feature values associated with different speeds;
based at least in part on the measured parameter, determining a sample feature value for a record that has been queried from the sensor data and comprises an unknown condition;
from the set of feature value differences, identifying a maximum value associated with a first feature value and a second feature value;
determining the greater of two differences between the sample feature value and each of the first and second feature values;
discarding from the set of feature value differences those that were obtained from the record for the speed associated with the greater of two differences;
returning to the step of identifying a maximum value until a single condition remains; and
responsive to the single condition remaining, outputting the single condition as a first estimated condition.

20. The system according to claim 19, wherein at least of the set of features and the first set of records has been randomly selected.
